(19) United States
(12) Patent Application Publication
(10) Pub. No.: US 2019/0130469 A1
(43) Pub. Date: May 2, 2019

(54) GENERATION OF INTERACTION-BASED KEYWORDS FOR SPONSORED PRODUCTS USING SEARCH QUERY INFORMATION

(71) Applicant: CRITEO SA, Paris (FR)

(72) Inventors: Jean-Baptiste Tien, Santa Clara, CA (US); Ekaterina Veber, Menlo Park, CA (US)

(21) Appl. No.: 15/922,715

(22) Filed: Mar. 15, 2018

Related U.S. Application Data
(60) Provisional application No. 62/578,918, filed on Oct. 30, 2017.

(51) Int. Cl. G06Q 30/06; G06Q 30/02; G06F 17/30

(52) U.S. Cl. CPC G06Q 30/0627; G06F 17/30389; G06Q 30/0253; G06Q 30/0256

(57) ABSTRACT

Described herein are methods and systems for generating interaction-based keywords for sponsored products using search query information. A client device executes a browser application to render one or more webpages of a website. A server receives one or more search keywords from a webpage displayed on the client device and determines a user interaction initiated at the client computing device with a product displayed in a first set of search results containing one or more products. The server associates at least one of the search keywords with the products based upon the user interaction, and determines sponsored products for display based upon the association between the search keywords and the products.

### RELATED APPLICATIONS

This application claims priority to U.S. Provisional Patent Application No. 62/578,918, filed on Oct. 30, 2017, which is incorporated herein by reference.

### TECHNICAL FIELD

This subject matter of this application relates generally to methods and apparatuses, including computer program products, for generating interaction-based keywords for sponsored products using search query information.

### BACKGROUND

Many e-commerce and retailer websites provide search capabilities that enable a user to enter certain search criteria (e.g., keywords, filters) relating to a product or service that the user is interested in. The websites typically apply the search criteria entered by the user to pre-configured keywords, text description, and similar metadata about the product or service, and determine whether there is similarity between the user's search criteria and the product keywords to produce search results containing products and services that match the search criteria. In addition, certain websites may provide the capability of augmenting the search results with sponsored results, meaning products or services that the retailer or advertiser wishes to include in the search results—usually in exchange for an advertising or placement fee.

However, the search results returned by a website based upon user-entered search criteria are often inaccurate or incomplete—because the metadata associated with the products or services may be too generic (resulting in the website not finding the right product matches), the search criteria may not accurately capture the specific products or services that the user is searching for (e.g., missing descriptors in a search query).

### SUMMARY

Therefore, what is needed are methods and systems to automatically generate keywords for products or services based upon organically-generated search criteria, and then associate the keywords to the particular products or services to which they apply, based upon a weighted correlation between a keyword and a product. The techniques described herein provide the technical advantage of generating such keywords programmatically based upon detection and aggregation of user interactions (e.g., clicks, views) with certain products after entering search keywords into the website. In addition, the techniques leverage advanced machine learning algorithms to predict the relevance of products for specific keywords.

The invention, in one aspect, features a system for generating interaction-based keywords for sponsored products using search query information. The system comprises a client computing device with a processor configured to execute a browser application to render one or more webpages of a website, and a server computing device with a processor configured to transmit webpage information for display on the client computing device. The server computing device receives one or more search keywords from a webpage displayed on the client computing device. The server computing device detects a user interaction initiated at the client computing device with a product displayed in a first set of search results containing one or more products in a webpage of the website. The server computing device associates at least one of the search keywords with the products based upon the user interaction. The server computing device determines one or more sponsored products for display based upon the association between the search keywords and the products.

The invention, in another aspect, features a computerized method of generating interaction-based keywords for sponsored products using search query information. A processor of a client computing device executes a browser application to render one or more webpages of a website, and a processor of a server computing device transmits webpage information for display on the client computing device. The server computing device receives one or more search keywords from a webpage displayed on the client computing device. The server computing device detects a user interaction initiated at the client computing device with a product displayed in a first set of search results containing one or more products in a webpage of the website. The server computing device associates at least one of the search keywords with the products based upon the user interaction. The server computing device determines one or more sponsored products for display based upon the association between the search keywords and the products.

Any of the above aspects can include one or more of the following features. In some embodiments, the server computing device generates a second set of search results based upon the search keywords, where the second set of search results includes one or more of the sponsored products in addition to one or more products from the first set of search results. In some embodiments, the second set of search results is displayed on the client computing device.

In some embodiments, associating at least one of the search keywords with the products based upon the user interaction comprises determining a first timestamp associated with receipt of the search keywords; determining a second timestamp associated with detection of the user interaction; and generating an association between at least one of the search keywords and the products when a difference between the first timestamp and the second timestamp is within a predetermined threshold. In some embodiments, the server computing device aggregates associations between at least one of the search keywords and the products across user interactions from a plurality of users. In some embodiments, the server computing device discards one or more of the aggregated associations after determining the aggregated association falls below a relevancy threshold.

In some embodiments, the sponsored products are associated with a retailer operating the website. In some embodiments, the sponsored products are associated with an advertiser.

Other aspects and advantages of the invention will become apparent from the following detailed description, taken in conjunction with the accompanying drawings, illustrating the principles of the invention by way of example only.

### BRIEF DESCRIPTION OF THE DRAWINGS

FIG. 1 is a block diagram of a system for generating interaction-based keywords for sponsored products using search query information.

FIG. 2 is a flow diagram of a method of generating interaction-based keywords for sponsored products using search query information.

### DETAILED DESCRIPTION

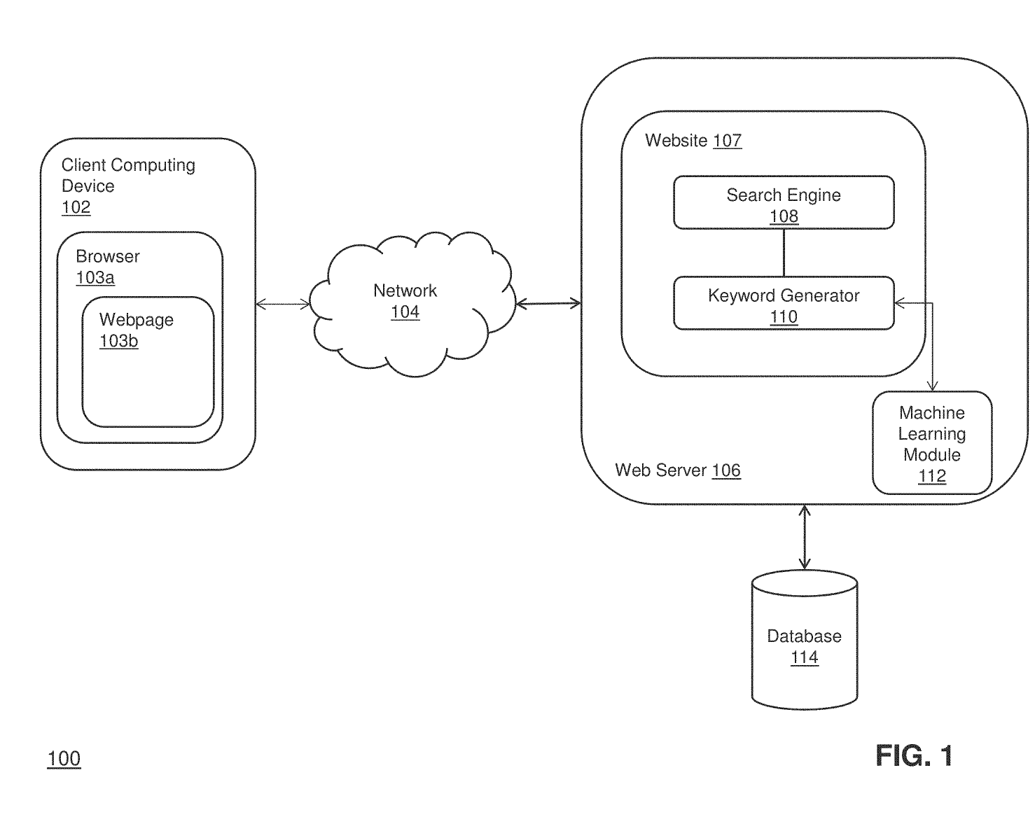

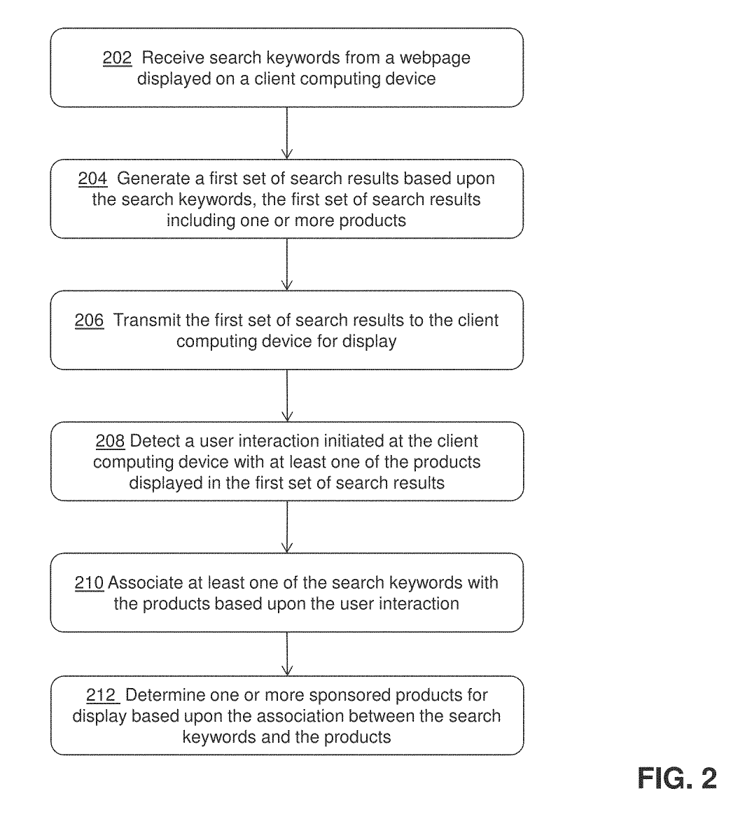

FIG. 1 is a block diagram of a system 100 for generating interaction-based keywords for sponsored products using search query information, and FIG. 2 is a flow diagram of a method of generating interaction-based keywords for sponsored products using search query information, using the system 100 of FIG. 1.

As illustrated, networked system 100 includes a client computing device 102 that is capable of executing a browser application 103a for presentation of webpages (e.g., webpage 103b) to a user at client computing device 102. Exemplary client devices 102 include but are not limited to desktop computers, laptop computers, tablets, mobile devices, and smartphones. It should be appreciated that other types of computing devices that are capable of connecting to the components of the system 100 can be used without departing from the scope of invention. Although FIG. 1 depicts a single client computing device 102, it should be appreciated that the system 100 can include any number of client devices.

The browser application 103a comprises software executing on a processor of the client computing device 102 that enables the client device to communicate via HTTP with remote servers addressable with URLs (e.g., web server 112) to receive website-related content, including webpages 103b, for rendering in the browser application and presentation on a display device coupled to the client device 102. Exemplary browser application software includes, but is not limited to, Internet Explorer™, Firefox™, Chrome™ and other similar software. The webpage 103b can comprise visual and audio content for display to and interaction with a user.

Networked system 100 can include a web server 106 (e.g., a computing device or devices) that hosts a website, to which the client computing device 102 connects to retrieve and display webpage 103b content. In some embodiments, the website is an e-commerce platform from a retailer selling online goods or services. In some embodiments, the website is an online content platform selling advertising placements (e.g., for ad creatives (audio/video ads), and other content). Typically, the website comprises a plurality of visual and non-visual elements that make up the content transmitted and displayed to a user when, e.g., browser software and/or application software 103a on a remote computing device 102 connects to the web server 106 via a communications network 104 (e.g., Internet) and requests content from the website. The elements of a website include, but are not limited to, webpages (e.g., HTML documents), image files, layouts, color sets, stylesheets, document object models (DOM), tracking elements, instrumentations (e.g., analytics, advertisement display, etc.), metadata, URLs, advertisements, and content (e.g., text, audio, video).

The network 104 enables the client computing device 102 and the web server 106 to communicate with each other in order to perform the process of generating interaction-based keywords for sponsored products using search query information as described herein. The network 104 may be a local network, such as a LAN, and/or a wide area network, such as the Internet and/or a cellular network. In some embodiments, the network 104 is comprised of several discrete networks and/or sub-networks (e.g., cellular to Internet) that enable the components of the system 100 to communicate with each other.

The web server 106 is a combination of hardware, including one or more special-purpose processors and one or more physical memory modules, and specialized software engines that execute on the processor of the web server 106, to receive data from other components of the system 100, transmit data to other components of the system 100, and perform functions relating to generating interaction-based keywords for sponsored products using search query information as described herein. The processor of the web server 106 executes a search engine 108, a keyword generator 110, and a machine learning module 112. In some embodiments, elements 108, 110 and 112 are specialized sets of computer software instructions programmed onto a dedicated processor in the web server 106 and can include specifically-designated memory locations and/or registers for executing the specialized computer software instructions. Further explanation of the specific processing performed by elements 108, 110, 112 will be provided below.

The search engine 108 receives (202) as input search keywords entered by a user of client computing device 102 via a webpage 103b (e.g., product keyword searches on e-commerce sites). The search engine 108 analyzes the search keywords entered into the webpage 103b and generates (204) a first set of search results that include relevant product listings similar to, related to, or otherwise relevant to the keywords and/or the retailer website. The search engine 108 transmits (206) the first set of search results to the client computing device 102 for display on the webpage 103b.

The keyword generator 110 detects (208) a user interaction initiated at the client computing device 102 with at least one of the products displayed in the search results, and associates (210) at least one of the search keywords entered by the user and the one or more products that the user has interacted with in the search results. For example, a user can type keywords into the webpage 103b, receive and view relevant products in the search results, then interact with (e.g., click, expand, view, hover, etc.) one or more products displayed in the search results. The keyword generator 110 captures the keywords entered by the user, the interaction with one or more products, and a timestamp that indicates how much time elapsed between entry of the keywords and the interaction, which indicates that the user was interested in a certain product that appeared in the search results, based upon the keywords entered. In one example, the keyword generator 110 associates a search keyword with a product if a user has typed the keyword and then interacted with the product less than sixty seconds later.

In some instances, the keyword generator 110 determines whether an association between a search keyword and a product should be kept or discarded. For example, the keyword generator 110 can aggregate the search keywords and interactions of multiple different users of the website 107 together and determine whether the associations between keywords and interactions meet or exceed a predetermined threshold—in order to eliminate potential keywords that may not be relevant or could be considered as statistical noise.

In one example, the keyword generator 110 can create an association matrix that shows the connection between keyword, product, and number of different users associating both:

| | | | # Different Users Associating |
|---|---|---|---|
| Index | Keyword | Product | Both |
| 1 | ‘shoes’ | Shoe:ProdID1 | 250 |
| 2 | ‘shoes’ | Shoe:ProdID2 | 125 |
| 3 | ‘shoes’ | Shoe:ProdID3 | 15 |
| 4 | ‘shoes’ | Battery:ProdID6 | 1 |
| 5 | ‘shoes’ | Boardgame:ProdID8 | 1 |

As shown above, a large number of users have associated the keyword ‘shoes’ to specific products (Shoe:ProdID1, Shoe:ProdID2, Shoe:ProdID3) but only one user has associated the keyword ‘shoes’ to Battery:ProdID6 and Boardgame:ProdID8. In this case, the keyword generator 110 can determine that the associations at index 1, 2 and 3 should be kept, while the associations at index 4 and 5 should be discarded.

The keyword generator 110 also utilizes two metrics to determine the strength of an association between keyword and product:
Product Exclusivity: For a given product, gather all the keywords associated with it, and assign a weight. The product exclusivity of a given couple PE(keyword, product)=weight(keyword)/weight(all keywords) for a given product. PE indicates, for a given product, how strongly each keyword ‘means’ to the particular product.
Keyword Exclusivity: For a given keyword, gather all the products associated with it, and assign a weight. The keyword exclusivity of a given couple KE(keyword, product)=weight(product)/weight(all products) for a given keyword. KE indicates, for a given keyword, how strongly each product ‘means’ to the particular keyword.

Generally, it is preferable to have a minimum threshold for Product Exclusivity and for Keyword Exclusivity in order to validate that the association should be kept. If Product Exclusivity and/or Keyword Exclusivity is too low, the keyword generator 110 can discard the association as not relevant enough.

In one example, the Product Exclusivity can be low when the product is very popular (e.g., a product on a homepage with a large rebate). To some extent, the given product attracts a lot of different keywords, such as in the following matrix:

| Index | Keywords | Product | Product Exclusivity |
|---|---|---|---|
| 1 | ‘electric’ ‘car’ ‘toy’ | Toy:ProdID1 | 60% |
| 2 | ‘electric’ ‘car’ ‘toy’ | Toy:ProdID1 | 30% |
| | ‘spider man’ | | |
| 3 | ‘doll’ | Toy:ProdID1 | 0.5% |

In the above example, the Product Exclusivity of the association between the keyword ‘doll’ and Toy:ProdID1 is very low so the keyword generator 110 may decide to discard this association.

In another example, the Keyword Exclusivity can be low when the keyword is very popular (e.g., a keyword that everyone is searching for). In this case, users may type the keyword in but then click on a different product, such as in the following matrix:

| Index | Keywords | Product | Product Exclusivity |
|---|---|---|---|
| 1 | ‘doll’ | Toy:ProdID1 | 60% |
| 2 | ‘doll’ | Toy:ProdID2 | 30% |
| 3 | ‘doll’ | Battery:ProdID6 | 1% |

In the example above, the Keyword Exclusivity of the association between the keyword ‘doll’ and Battery:ProdID6 is very low so the keyword generator 100 may decide to discard this association.

The search engine 108 receives the associations generated by the keyword generator 110 and determines (212) one or more sponsored products for display on the client computing device 102 based upon the associations between the search keywords entered by the user and the products originally retrieved by the search engine 108. For example, one or more sponsored products may have characteristics that are similar to, or related to, one or more characteristics of products in the organically-produced search results. The search engine 108 can use the associations between keywords linked to the products, and then link the keywords to the sponsored products for inclusion in the search results.

In some embodiments, the machine learning module 112 utilizes the associations generated by the keyword generator 110 to predict relevant keywords for particular products, and to predict relevant products for particular keywords. The machine learning module 112 can use a regression model to, e.g., take as inputs certain keywords entered by a user and predict which products are likely relevant to the keywords, based upon the existing association data—even if the keywords are not currently associated with any products. Similarly, the machine learning module 112 can take as inputs certain products at a retailer site and predict which keywords are likely relevant to the products, based upon the existing association data. In addition, the machine learning module 112 can then use these predictions to generate new associations automatically, to strengthen the relevant search results and sponsored products returned in the webpage 103b search. In this way, the system 100 leverages advanced computing techniques to automatically generate associations without the need for manual processes.

The database 114 is a computing device (or in some embodiments, a set of computing devices) that is coupled to the web server 106 and is configured to receive, generate, and store specific segments of data relating to the process of generating interaction-based keywords for sponsored products using search query information as described herein. In some embodiments, all or a portion of the database 114 can be integrated with the web server 106 or be located on a separate computing device or devices. For example, the database 114 can comprise one or more databases, such as MySQL™ available from Oracle Corp. of Redwood City, Calif.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more specialized processors executing a computer program to perform functions by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A system for generating interaction-based keywords for sponsored products using search query information, the system comprising:
a client computing device with a processor configured to execute a browser application to render one or more webpages of a website; and
a server computing device with a processor configured to transmit webpage information for display on the client computing device,
the server computing device configured to:
detect a user interaction initiated at the client computing device with at least one product displayed in a first set of search results containing one or more products in a webpage of the website;
associate at least one of the search keywords with the products based upon the user interaction;
determine one or more sponsored products for display based upon the association between the search keywords and the products.

2. The system of claim 1, wherein the server computing device generates a second set of search results based upon the search keywords, wherein the second set of search results includes one or more of the sponsored products in addition to one or more products from the first set of search results.

3. The system of claim 2, wherein the second set of search results is displayed on the client computing device.

4. The system of claim 1, wherein associating at least one of the search keywords with the products based upon the user interaction comprises:
determining a first timestamp associated with receipt of the search keywords;
determining a second timestamp associated with detection of the user interaction; and
generating an association between at least one of the search keywords and the products when a difference between the first timestamp and the second timestamp is within a predetermined threshold.

5. The system of claim 1, wherein the server computing device aggregates associations between at least one of the search keywords and the products across user interactions from a plurality of users.

6. The system of claim 5, wherein the server computing device discards one or more of the aggregated associations after determining the aggregated association falls below a relevancy threshold.

7. The system of claim 1, wherein the sponsored products are associated with a retailer operating the website.

8. The system of claim 1, wherein the sponsored products are associated with an advertiser.

9. A computerized method of generating interaction-based keywords for sponsored products using search query information, the method comprising:
executing, by a processor of a client computing device, a browser application to render one or more webpages of a website;
receiving, by a processor of a server computing device coupled to the client computing device, one or more search keywords from a webpage displayed on the client computing device;
detecting, by the processor of the server computing device, a user interaction initiated at the client computing device with a product displayed in a first set of search results containing one or more products in a webpage of the website;
associating, by the processor of the server computing device, at least one of the search keywords with the products based upon the user interaction; and
determining, by the processor of the server computing device, one or more sponsored products for display based upon the association between the search keywords and the products.

10. The method of claim 9, wherein the server computing device generates a second set of search results based upon the search keywords, wherein the second set of search results includes one or more of the sponsored products in addition to one or more products from the first set of search results.

11. The method of claim 10, wherein the second set of search results is displayed on the client computing device.

12. The method of claim 9, wherein associating at least one of the search keywords with the products based upon the user interaction comprises:
determining a first timestamp associated with receipt of the search keywords;
determining a second timestamp associated with detection of the user interaction; and
generating an association between at least one of the search keywords and the products when a difference between the first timestamp and the second timestamp is within a predetermined threshold.

13. The method of claim 9, wherein the server computing device aggregates associations between at least one of the search keywords and the products across user interactions from a plurality of users.

14. The method of claim 13, wherein the server computing device discards one or more of the aggregated associations after determining the aggregated association falls below a relevancy threshold.

15. The method of claim 9, wherein the sponsored products are associated with a retailer operating the website.

16. The method of claim 9, wherein the sponsored products are associated with an advertiser.
